(19) United States
(12) Patent Application Publication
(10) Pub. No.: US 2021/0065312 A1
(43) Pub. Date: Mar. 4, 2021

(54) SOCIAL MEDIA INFORMATION PROCESSING METHOD AND SYSTEM

(71) Applicant: NATIONAL CHIAO TUNG UNIVERSITY, Hsinchu-City (TW)

(72) Inventors: Pai-Hui WANG, Taipei City (TW); Chien-Chao TSENG, Hsinchu City (TW); Ted Tse-I KUO, Kaohsiung City (TW)

(21) Appl. No.: 16/941,529

(22) Filed: Jul. 28, 2020

(30) Foreign Application Priority Data
Aug. 26, 2019 (TW) 108130492

(51) Int. Cl. G06Q 50/00; G06F 16/901; G06F 17/18

(52) U.S. Cl. CPC G06Q 50/01; G06F 17/18; G06F 16/9027

(57) ABSTRACT

A social media information processing method includes following steps. First tags, a first data tag tree and a first tag frequency pattern related to a first input image are read. A second input image is inputted. A second tag related to the second input image is generated according to the second input image. A first pattern count of the first tag frequency pattern is updated according to the second tag. Some first-layer nodes and some lower-layer node in an index tag tree involving the second tag are adjusted, to generate a new index tag tree. Display contents on a user interface are adjusted according to the new index tag tree.

### CROSS-REFERENCE TO RELATED APPLICATION

This application claims priority to Taiwan Application Serial Number 108130492, filed Aug. 26, 2019, which is herein incorporated by reference in its entirety.

### BACKGROUND

### Field of Invention

The present invention relates to social media information processing method and system.

### Description of Related Art

With the advancement of technology and the popularization of mobile devices, people often use mobile devices to shoot images, and then share each other on a home network or share images on a social network.

The shared images are all in the folder classification mode for the user to browse. When the user wants to browse a specific image, the browsing efficiency is often not good because the user does not understand the way of classifying the image into the folder. Therefore, it is one of the important topics in the field how to enable users to browse the content of interest regardless of whether they are on a home network or a social network, which can effectively improve the efficiency of browsing and searching.

### SUMMARY

The invention provides a social media information processing method. The method includes: reading a plurality of first tags, a first data tag tree and a plurality of first tag frequency patterns related to a plurality of first input images; inputting a plurality of second input images; generating a plurality of second tags related to the plurality of second input images according to a plurality of second input images; updating a plurality of first pattern counts of the plurality of first tag frequency patterns according to the plurality of second tags; adjusting a plurality of first-layer nodes and a plurality of lower-layer nodes involving the plurality of second tags in an index tag tree, to generate a new index tag tree; and adjusting a display content of a user interface according to the new index tag tree, wherein the display content comprises a tag cloud and a tag quantity display row, wherein the tag cloud and the tag quantity display row are configured to display a correlation between the plurality of first tags of the plurality of first input images and the plurality of second tags of the plurality of second input images.

In one embodiment, the steps of updating the plurality of first pattern counts of the plurality of first tag frequency patterns includes: comparing contents of the plurality of first tags of the first data tag tree with the plurality of second tags; reading a plurality of statistical quantities of nodes, which match the plurality of second tags, in the first data tag tree; summing the plurality of statistical quantities and a tag quantity generated by each of the plurality of second tags to generate a plurality of new statistical quantities; generating a second data tag tree according to the plurality of new statistical quantities and the plurality of second tags, wherein a plurality of nodes of the second data tag tree respectively correspond to one of the second tags; generate a second tag frequency pattern table according to the second data tag tree, wherein the second tag frequency pattern table comprises a plurality of second tag frequency patterns and a plurality of second pattern counts of the plurality of second tag frequency patterns, and each of the second tag frequency patterns is any combination of each of the second tags; acquiring one of first tag frequency patterns in the first tag frequency pattern table which matches contents of the second tag frequency patterns in the second tag frequency pattern table, and updating the first pattern count of a matched first tag frequency pattern to the second pattern count of the second tag frequency pattern which the content is matched; and acquiring one of first tag frequency patterns which do not matches the contents of the second tag frequency patterns, and maintaining the first pattern count of the first tag frequency pattern which is not matched.

In one embodiment, the steps of generating the index tag tree includes: reading the index tag tree, the plurality of first-layer nodes and the plurality of lower-layer nodes in the index tag tree; reading the plurality of new statistical quantities generated by summing the plurality of statistical quantities of the nodes in the first data tag tree which match the plurality of second tags and tag quantities generating by each of the second tags; reading the updated first tag frequency pattern table; generating a new tag quantity sorting according to the new statistical quantities when the plurality of second tags exist in the plurality of first-layer nodes of the index tag tree; determining a part of the plurality of first-layer nodes that need to be changed according to the new tag quantity sorting; determining a part of the plurality of lower-layer nodes that need to be changed according to a part of the plurality of first-layer nodes that need to be changed; releasing a part of the plurality of lower-layer nodes that need to be changed and an original connection relationship of a part of the first-layer nodes that need to be changed according to a part of the lower nodes that need to be changed; establishing a new connection relationship between a part of the plurality of lower-layer nodes that need to be changed and a part of the plurality of first-layer nodes that need to be changed according to the new tag quantity sorting; updating contents of the second tags of a part of the plurality of lower-layer nodes to be changed according to the new connection relationship; according to the new connection relationship, releasing the original horizontal links of a part of the plurality of lower-layer nodes that need to be changed and a part of the plurality of first-layer nodes that need to be changed, and establishing a plurality of new horizontal links of a part, which has been changed, of the plurality of lower-layer nodes and a corresponding part of the plurality of first-layer nodes that need to be changed; updating orders of the plurality of first-layer nodes and the plurality of lower-layer nodes according to the new tag quantity sorting, updating statistical quantities of the plurality of first-layer nodes according to the tag quantity of the second tag, and updating statistical quantities of the plurality of lower-layer nodes according to the updated first tag frequency pattern table.

In one embodiment, the steps of generating the plurality of first tags, the first data tag tree, and the plurality of tag frequency patterns includes: inputting the plurality of first input images; generating the plurality of first tags related to the plurality of first input images according to the plurality of first input images; establishing a tag quantity sorting according to tag quantity statistics generated by each of the plurality of first tags; reading the plurality of first tags related to the plurality of first input images according to the tag quantity sorting, and establishing the first data tag tree according to correlations of the plurality of first tags, wherein a plurality of nodes of the first data tag tree respectively correspond to one of the plurality of first tags; and generating a first tag frequency pattern table according to the first data tag tree, wherein the first tag frequency pattern table includes the plurality of first tag frequency patterns and a plurality of first pattern counts of the plurality of first tag frequency patterns, wherein each of the plurality of first tag frequency patterns is any combination of each of the plurality of first tags.

In one embodiment, the steps of generating the index tag tree, the plurality of first-layer nodes and the plurality of lower-layer nodes in the index tag tree includes: determining whether the tag quantity generated by each of the plurality of first tags is greater than an index tag quantity threshold; creating each of the plurality of first tags into the plurality of first-layer nodes of the index tag tree in order from small to large according to the tag quantity sorting of the plurality of first tags when the tag quantity of the first tag is greater than the index tag quantity threshold, wherein the index tag tree includes the plurality of first-layer nodes and the plurality of lower-layer nodes, wherein each of the plurality of first-layer nodes and each of the plurality of lower-layer nodes respectively correspond to one of the plurality of first tags; reading the plurality of first tag frequency patterns according to the plurality of first-layer nodes of the index tag tree, and arranging each of the plurality of tag frequency patterns according to the tag quantity sorting in reverse order from large to small from the plurality of lower-layer nodes; establishing a plurality of horizontal links to the plurality of lower-layer nodes that match first tags of the plurality of first-layer nodes according to the plurality of first-layer nodes of the index tag tree; and not creating the first tag into the index tag tree when the tag quantity of the first tag is smaller than the index tag quantity threshold.

In one embodiment, when the client terminal shares the input image to the home network, the method of sharing data by tag relationship further includes: generating a home index tag tree provided to a plurality of client terminals according to the input images shared by the plurality of client terminals and a plurality of index tag tree shared by the plurality of client terminals.

In one embodiment, when the client terminal shares the plurality of input images to the home network, the method of sharing data by tag relationship further includes: selecting the plurality of input images to be shared by a plurality of client terminals, selecting the index tag tree to be shared by the plurality of client terminals, and selecting a plurality of sharing targets to be shared by the plurality of client terminals; and generating a social network index tag tree provided to the plurality of sharing targets according to the plurality of input data that the plurality of client terminals want to share and the index tag tree that the plurality of client terminals want to share.

The invention provides a social media information processing system. The system includes an input unit, a processing unit and an output unit. The input unit configured to input a plurality of first input images and a plurality of second input images shared by a plurality of client terminals. The processing unit configured to generate the new index tag tree according to the plurality of first input images and the plurality of second input images. The output unit configured to display an output result of the new index tag tree, wherein the new index tag tree affects the display result of a tag cloud and a tag quantity display column of an user interface, wherein the tag cloud and the tag quantity display column show correlations between the plurality of first tags of the plurality of first input images and the plurality of second tags of the plurality of second input images.

In one embodiment, the social media information processing system further includes: a home network server configured to output a home index tag tree provided to the plurality of client terminals according to the plurality of first input images and the plurality of second input images shared by the plurality of client terminals and a plurality of index tag trees shared by the plurality of client terminals.

In one embodiment, the social media information processing system further includes: a social network server configured to select the plurality of input images that the plurality of client terminals want to share, selecting the plurality of index tag trees that the plurality of client terminals want to share, and selecting a plurality of sharing targets that the plurality of client terminals want to share, wherein the social network server outputs a social network index tag tree provided to the plurality of sharing targets according to the plurality of input data that the plurality of client terminals want to share and the plurality of index tag trees that the plurality of client terminals want to share.

In summary, in the invention, by applying the social media information processing system and method in the above each of embodiments, the content of interest on the user can be quickly and efficiently browsed on the home network or the social network based on the tag association of the index tag tree.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a social media information processing according to some embodiments of the present disclosure.

FIG. 2 is a flowchart of a social media information processing method 200 according to some embodiments of the present disclosure.

FIG. 3 is a schematic diagram of a first input image and the generated first tags according to some embodiments of the present disclosure.

FIG. 4 is a schematic diagram of creating a tag quantity sorting according to some embodiments of the present disclosure.

FIG. 5 is a schematic diagram of a process of establishing a first data tag tree according to some embodiments of the present disclosure.

FIG. 6 is a schematic diagram of a first tag frequency pattern table SFP1 according to some embodiments of the present disclosure.

FIG. 7A is a schematic diagram of first-layer nodes FLN for creating an index tag tree IT according to some embodiments of the present disclosure.

FIG. 7B is a schematic diagram of establishing lower-layer nodes LLN of the index tag tree IT according to some embodiments of the present disclosure.

FIG. 7C is a schematic diagram of creating horizontal links HL of an index tag tree IT according to some embodiments of the present disclosure.

FIG. 8 is a flowchart of a social media information processing method 800 after a new image is input according to some embodiments of the present disclosure.

FIG. 9 is a schematic diagram of establishing a second data tag tree TT2 according to some embodiments of the present disclosure.

FIG. 10 is a schematic diagram of generating a new first tag frequency pattern table NSFP1 according to some embodiments of the present disclosure.

FIG. 11 is a schematic diagram of updating the tag quantity sorting TS according to some embodiments of the present disclosure.

FIG. 12 is a schematic diagram of determining changing parts of the index tag tree according to some embodiments of the present disclosure.

FIG. 13 is a schematic diagram of updating connection relationship of an index tag tree according to some embodiments of the present disclosure.

FIG. 14 is a schematic diagram of updating contents of the lower-layer nodes LLN and the horizontal links HL according to some embodiments of the present disclosure.

FIG. 15 is a schematic diagram of updating of the arrangement order and quantity of the first-layer nodes FLN and the lower-layer nodes LLN of an index tag tree according to some embodiments of the present disclosure.

FIG. 16 is a schematic diagram of outputting an index tag tree according to some embodiments of the present disclosure.

### DETAILED DESCRIPTION

The following is a detailed description of the embodiments in conjunction with the accompanying drawings to better understand the appearance of the invention, but the embodiments provided are not intended to limit the scope covered by the disclosure. The description of the structural operations is not intended to limit the order of execution. Any structure recombined by the components to produce devices with equal effects is within the scope of the disclosure. In addition, according to standards and common practices of the industry, the drawings are only for the purpose of auxiliary description, and are not drawn according to the original size. In fact, the size of various features can be arbitrarily increased or decreased for ease of description. In the following description, the same elements will be described with the same symbols to facilitate understanding.

The terms used in the entire specification and the claims, unless otherwise specified, usually have the ordinary meaning that each term is used in this field, in the content disclosed here, and in the special content. Certain terms used to describe the present disclosure will be discussed below or elsewhere in the specification to provide additional guidance to those skilled in the art in describing the present disclosure.

In addition, the terms “including”, “comprising”, “having”, “containing”, etc. used in the document are all open terms, meaning “including but not limited to”. In the document, when an element is called “connected” or “coupled”, it can be referred to as “electrically connected” or “electrically coupled.” “Connected” or “coupled” can also be used to indicate the operation or interaction between two or more components. Further, although terms such as “first”, “second”, etc. are used in this document to describe different elements, the terms are only used to distinguish elements or operations described in the same technical terms. Unless the context clearly dictates, the term does not specifically refer to or imply order or order, nor is it intended to limit the invention.

When the photos taken by the mobile device are shared at the home network or the social network, users currently browse the content they are interested in by searching and searching folders, which causes the problem of inefficient browsing and searching. In order to solve the above problems, the disclosure proposes the social media information processing system and method, which presents and guides users using the home network or the social network to browse content of interest with tags, which can effectively improve the efficiency of browsing and searching.

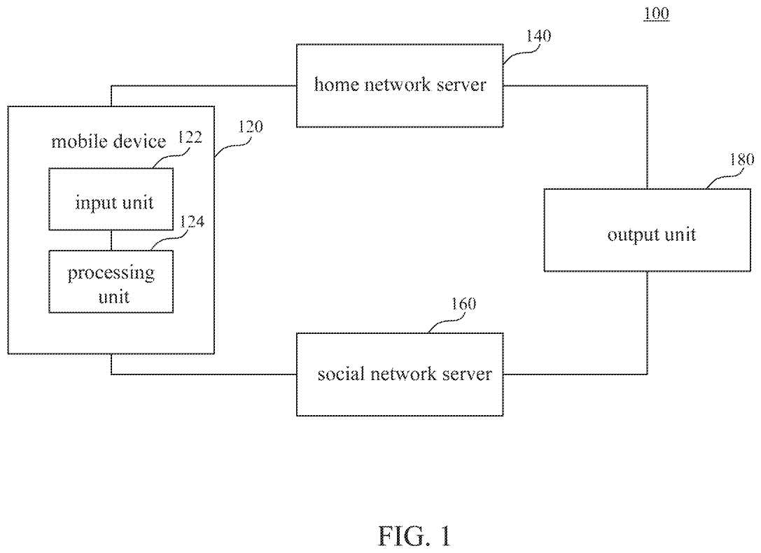

FIG. 1 is a schematic diagram of a social media information processing 100 according to some embodiments of the present disclosure. As shown in FIG. 1, the social media information processing system 100 includes a mobile device 120, a home network server 140, a social network server 160, and an output unit 180. The mobile device 120 includes an input unit 122 and a processing unit 124.

Please refer to FIG. 1, in terms of connection relationship, the mobile device 120 is connected to the home network server 140 and the social network server 160 via the internet, and the input unit 122 is coupled to the processing unit 124, and the home network server 140 and the social network server 160 are all connected to the output unit 180 via the internet.

In practice, for example, the mobile device 120 may be a smartphone or a tablet computer for data input and data output, and the input unit 122 may be a touch panel for selecting and inputting information.

The processing unit 124 may be an integrated circuit such as a micro controller, a microprocessor, a digital signal processor (DSP), an application specific integrated circuit (ASIC), a complex programmable logic device (CPLD) or logic circuit, or any person of ordinary skill in the art can think of the same function to perform calculations and process data within the limit of the disclosure document.

The home network server 140 and the social network server 160 may be cloud servers, which are responsible for data calculation and processing.

The output unit 180 may be a user interface of a smart phone, tablet computer, personal computer, smart TV, or other electronic device with a web browsing function for information display.

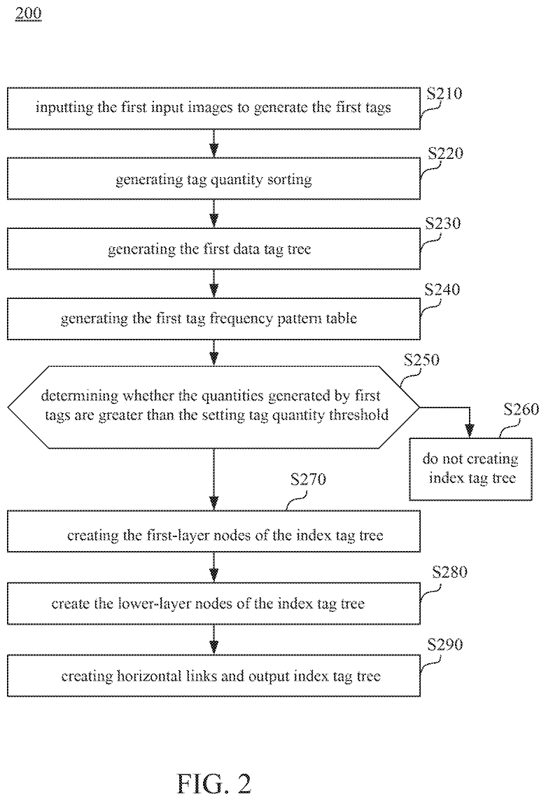

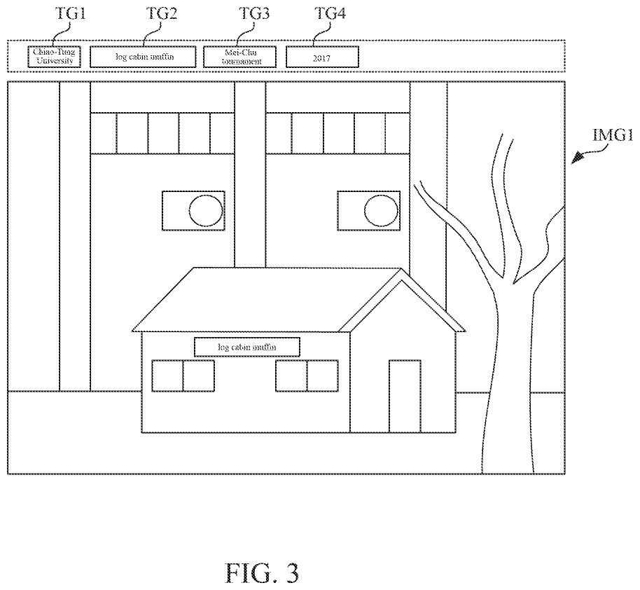

Please refer to FIG. 2 and FIG. 3 together, and FIG. 2 is a flowchart of a social media information processing method 200 according to some embodiments of the present disclosure, and FIG. 3 is a schematic diagram of a first input image and the generated first tags according to some embodiments of the present disclosure. As shown in FIG. 2, the social media information processing method 200 includes steps S210 to S290. In step S210, the user selects and inputs a plurality of first input images IMG1 with the input unit 122 of the mobile device 120, and automatically generates a plurality of first tags TAG1 for a content of each of the first input image IMG1 through the processing unit 124. The first tag TAG1 includes a place tag, a calendar tag, and a time tag. Taking FIG. 3 as an example, FIG. 3 is the first input image IMG1 shoot in the log cabin muffin shop by a user watching the Mei-Chu tournament at the Chiao-Tung University in 2017, and the plurality of first tags TAG1 automatically generated by the processing unit 124 for FIG. 3 are a tag TG1 (which represents the Chiao-Tung University), a tag TG2 (which represents the log cabin muffin), a tag TG3 (which represents the Mei-Chu tournament), and a tag TG4 (which represents 2017) respectively, where the tags TG1 and TG2 are location tags, the tag TG3 is a calendar tag, and the tag TG4 is a time tag.

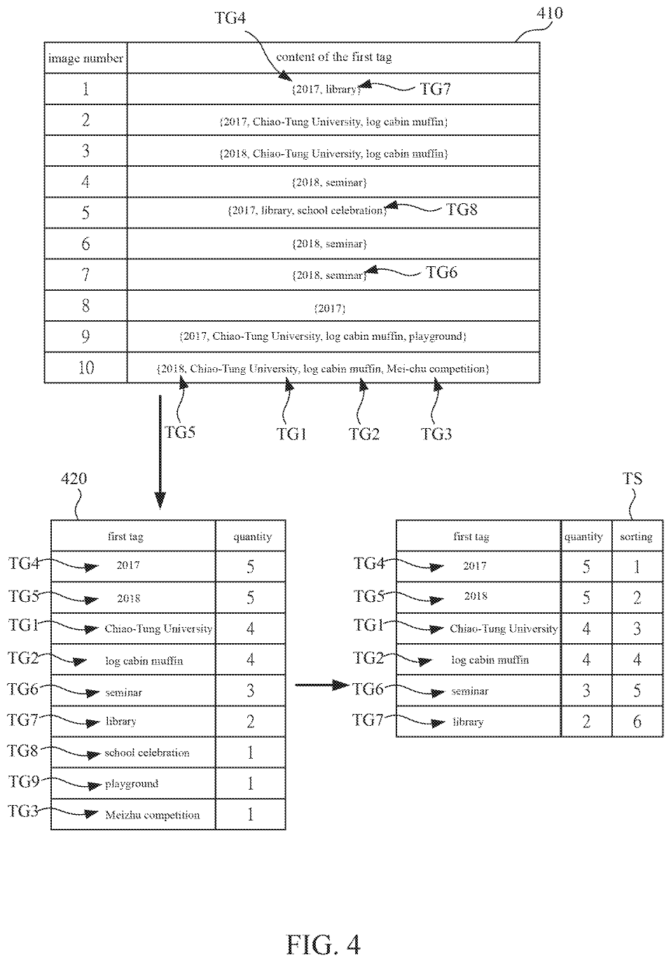

Next, in step S220, please refer to FIG. 4, and FIG. 4 is a schematic diagram of creating a tag quantity sorting according to some embodiments of the present disclosure. The processing unit 124 automatically generates a plurality of first tags TAG1 for the contents of the plurality of first input images IMG1 to create a first tag data table 410. In one embodiment, there are 10 first input images IMG1 (numbers are from 1 to 10) input in the first tag data table 410, and each first input image IMG1 automatically generates its own first tag TAG1. In this embodiment, the first tags TAG1 includes nine types of tags TG1-TG9 (It represents the Chiao-Tung University, the log cabin muffin, the Mei-Chu tournament, 2017, 2018, the seminar, the library, the school celebration, the playground, etc.) and is not limited thereto. In the first tag data table 410, the first input image of number 1 automatically generates first tags TAG1 including tags TG4 and TG7, and the first input image of number 2 automatically generates first tags TAG1 including tags TG4, TG1 and tags TG2. By analogy, the first input image of number 10 automatically generates first tags TAG1 including tag TG5, tag TG1, tag TG2, and tag TG3. Then, a quantity automatically generated by each of first tags TAG1 in the first tag data table 410 is made statistics to generate a first tag quantity statistics table 420. In the first tag quantity statistics table 420, if quantities are greater than the quantity threshold CV set by the user, the tag quantity sorting TS would be generated according to the quantities of each of first tag quantities, and if quantities automatically generated by the first tags are small than the quantity threshold CV set by the user, it would not be included in the tag quantity sorting TS. The first tags TAG1 in the tag quantity sorting TS are sorted from the tag TG4 which quantity is 5 in a way that the number is large to small to the tag TG7 which quantity is 2. Quantities of tags TG3, TG8 and TG9 are all 1, and they are smaller than the threshold value CV2 set by the user in this embodiment, so they are not included in the tag quantity sorting TS. The remaining first tags TAG1 (tags TG1, TG2 and TG4-TG7) are all greater than the quantity threshold CV2 set by the user, so they are included in the tag quantity sorting TS.

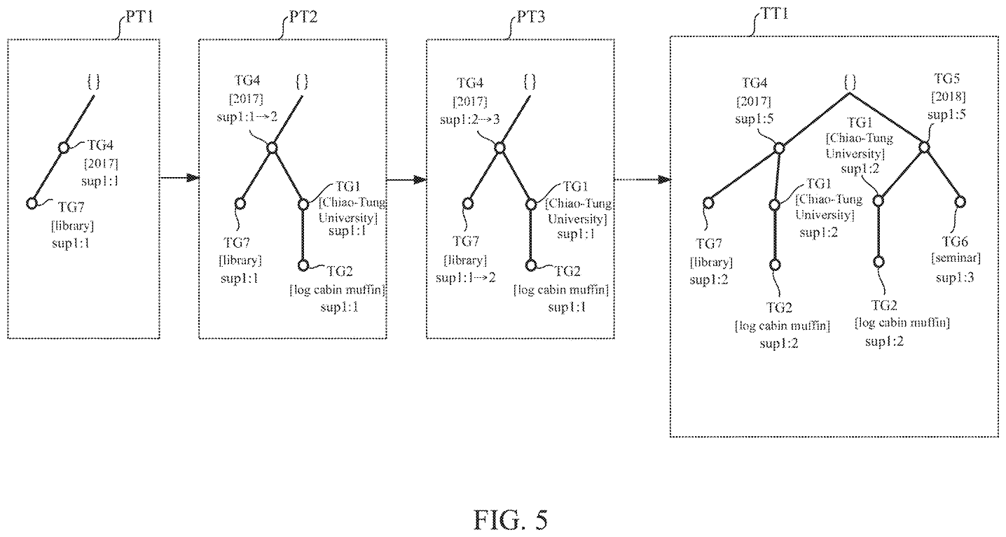

Next, in step S230, the processing unit 124 reads the plurality of first tags TAG1 of the plurality of first input images IMG1 according to the tag quantity sorting TS to create a first data tag tree TT1. Please refer to FIG. 4 and FIG. 5 together, and FIG. 5 is a schematic diagram of a process of establishing a first data tag tree according to some embodiments of the present disclosure. In one embodiment, according to the tag quantity sorting TS in FIG. 4, starting with the tag TG4 of the highest rank, the processing unit 124 reads the first tags, which include the tag TG4 and the tag TG7, generated by the first input image IMG1 of the number 1 in the first tag data table 410 to form the first type PT1 of the first data tag tree. The first type PT1 of the first data tag tree includes the node of the first tag TAG1 and the statistical quantity of the specific tags represented by each node. This is called the first support degree sup1. Therefore, at this time, the tag TG4 (2017) and tag TG7 (library) are generated and the two first tags TAG1 are used as contents of nodes, and the respective first support degrees sup1 are both 1. Next, the processing unit 124 continues to read the tags generated by the first input image IMG1 of the number 2 in the first tag data table 410 according to the tag quantity sorting TS, where the tags include the tag TG4, the tag TG1 and the tag TG2. Since the tag TG4 originally exists on the node of the first type PT1 of the first data tag tree, as long as the first support degree sup1 of the tag TG4 is changed from 1 to 2, and the nodes of tag TG1 and tag TG2 which first support degree sup1 are all 1 are generated. Next, the processing unit 124 continues to read the tag TG4, the tag TG7, and the tag TG8 generated by the first input image IMG1 of the number 5 in the first tag data table 410 via the tag TG4 according to the tag quantity sorting TS to form the third type PT3 of the first data tag tree. As long as the first support degree sup1 of the tag TG4 is changed from 2 to 3 and the first support degree sup1 of the tag TG7 is changed from 1 to 2. The tag TG8 is not considered because of insufficient quantity of the tag TG8 in the tag quantity sorting TS, so there is no need for showing in the process of establishing the first data tag tree TT1. By analogy, the processing unit 124 reads the tags (including tag TG5, tag TG1, tag TG2 and tag TG3) generated by the first input images IMG1 of the numbers 4-10 in the first tag data table 410 one by one, and after reading the multiple tags generated by the first input image IMG1 of the number 10 in the first tag data table 410, the establishment of the first data tag tree TT1 is completed immediately.

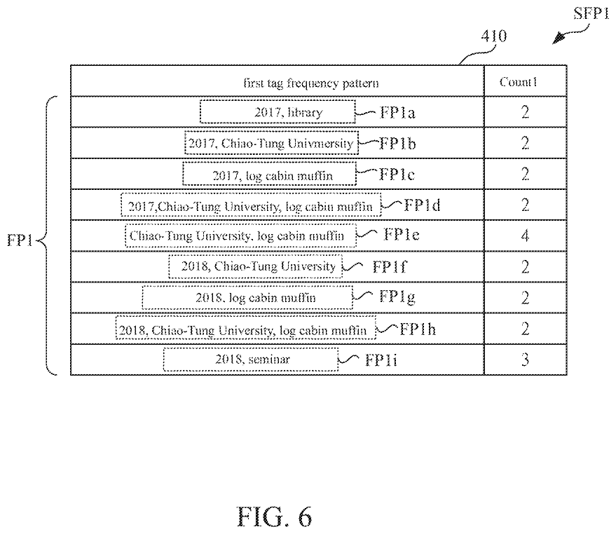

Next, in step S240, please refer to FIG. 6, and FIG. 6 is a schematic diagram of a first tag frequency pattern table SFP1 according to some embodiments of the present disclosure. The processing unit 124 generates a first tag frequency pattern table SFP1 according to the tag content and its first support degree sup1 of each node of the first data tag tree TT1. The first tag frequency pattern table SFP1 includes multiple first tag frequency patterns FP1, and the quantity thereof is the first pattern count Count1, and each of the first tag frequency patterns FP1 includes one or more tags. Taking the first tag frequency pattern FP1a in the first tag frequency pattern table SFP1 as an example, the content of the first tag frequency pattern FP1a includes the tag TG4 and the tag TG7. The first pattern count Count1 of the first tag frequency pattern FP1a is 2, which means that the quantity of tag combinations of contents of the tags TG4 and TG7 in the first data tag tree TT1 is 2. By analogy, all the first tag frequency patterns FP1 and the first pattern counts Count1 in the first data tag tree TT1 can be calculated to complete the first tag frequency pattern table SFP1.

Next, in step S250, the processing unit 124 compares the quantities of tags generated by the plurality of first input images IMG1 in the first tag quantity statistics table 420 with the index tag quantity threshold ITV. The index tag quantity threshold ITV is the minimum value of first tags TAG1 that the user expects to browse on the index tag tree IT. In an embodiment, please refer to FIG. 4 together, the index tag quantity threshold ITV is 2. If it is determined that quantities of the tags in the first tag quantity statistical table 420 is lower than the index tag quantity threshold IW which is 2, the process proceeds to step S260. If it is determined that quantities of the remaining tags in the first tag quantity statistical table 420 is greater than the index tag quantity threshold ITV which is 2, the process proceeds to step S270.

In step S260, because the processing unit 124 determines that the quantities of tags TG8, TG9, and TG3, which are 1, are lower than the index tag quantity threshold IW, which is 2, the tags TG8, TG9 and TG3 would not be included in the index tag tree IT.

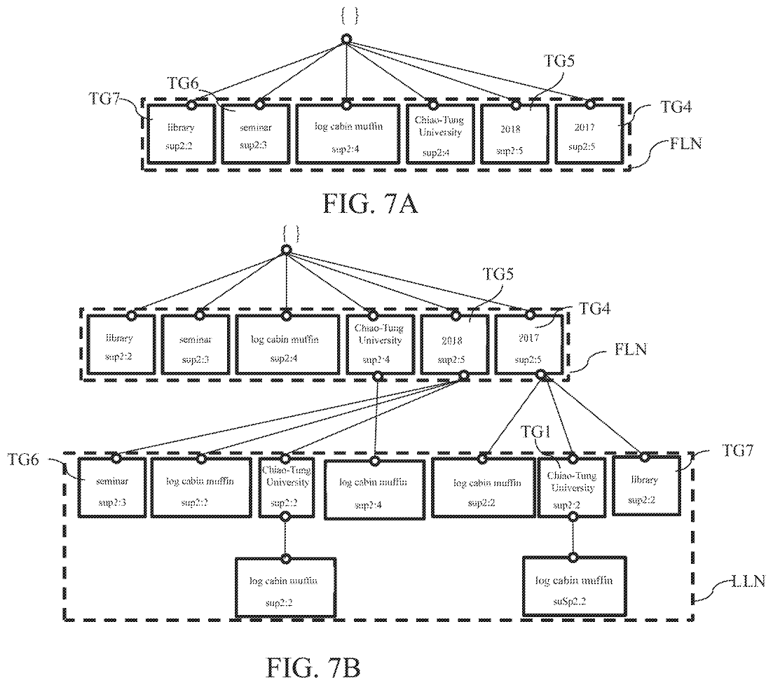

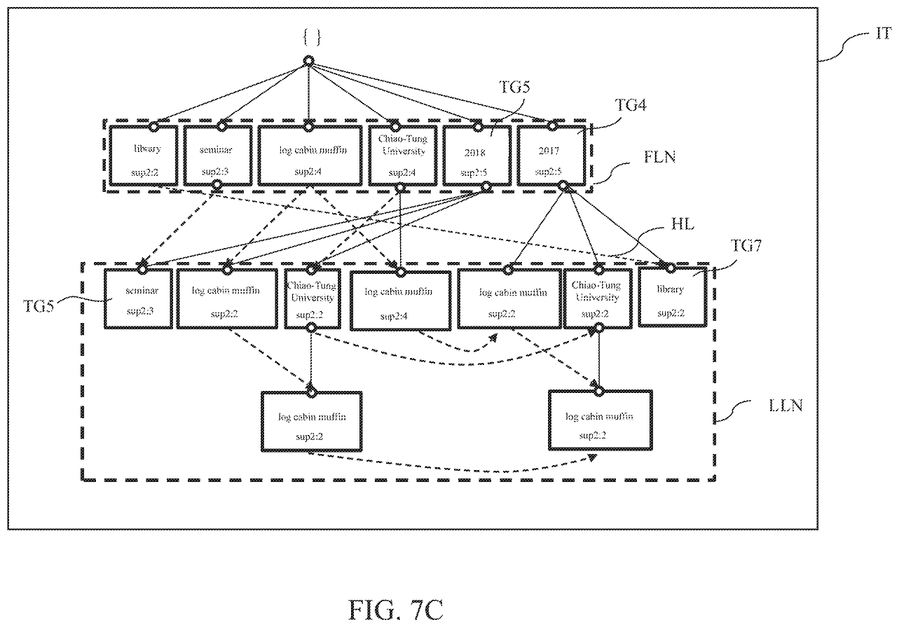

Next, in step S270, please refer to FIG. 4 together, and the processing unit 124 creates the first tag which number is greater than the index tag quantity threshold IW into the index tag tree IT. The index tag tree IT includes multiple first-layer nodes FLN and multiple lower-layer nodes LLN. The establishment process of the index tag tree IT will be explained in detail in the next steps. In one embodiment, please refer to FIG. 4 and FIG. 7A together, and FIG. 7A is a schematic diagram of first-layer nodes FLN for creating an index tag tree IT according to some embodiments of the present disclosure. The processing unit 124 creates the first-layer node FLN of the index tag tree IT from the lowest-ranked tag TG7 to the right according to the tag quantity sorting TS, and then creates the tag TG6 into. By analogy, until the highest sorted tag TG4 is built into the first-layer node FLN of the index tag tree IT. Statistical quantities of numbers of tag occurrences in the first-layer node FLN is referred to here as the second support degree sup2. Taking the leftmost node of the first-layer node FLN as an example, the second support degree sup2 of the tag TG7 is 2.

Next, in step S280, please refer to FIG. 4, FIG. 6, FIG. 7A, and FIG. 7B together, and FIG. 7B is a schematic diagram of establishing lower-layer nodes LLN of the index tag tree IT according to some embodiments of the present disclosure. The processing unit 124 reads multiple first tag frequency patterns FP1a to FP1i in FIG. 6 sequentially from the highest sorted tag according to an opposite method of the tag quantity sorting TS in FIG. 4 and the first-layer node FLN in FIG. 7A, to create the lower-layer node LLN of the index tag tree IT. In an embodiment, as shown in FIG. 7B, taking the first data in the first tag frequency pattern table SFP1 as an example, the content of the first tag frequency pattern FP1a is 2017 and the library, and its first pattern count Count1 is 2. According to the tag TG4 (2017) of the first-layer nodes FLN, it creates the lower-layer node LLN of the tag TG7 (the library) and its second support degree sup2 is 2. Next, the content of the first tag frequency pattern FP1b sorted second is 2017 and the Chiao-Tung University, and its first pattern count Count1 is 2. According to the tag TG4 (2017) of the first-layer nodes FLN, it create the lower-layer node LLN of the tag TG1 (the Chiao-Tung University), and its second support degree sup2 is 2. By analogy, the content of the first tag frequency pattern FP1i sorted 9th in order is 2018 and the seminar, and its first pattern count Count1 is 3. According to the tag TG5 of the first-layer nodes FLN, the second support degree sup2 of the tag TG6 is 3. In this way, each of the first tag frequency patterns FP1a to FP1i is built in the lower-layer nodes LLN of the index tag tree IT.

Next, in step S290, please refer to FIGS. 7B and 7C together, and FIG. 7C is a schematic diagram of creating horizontal links HL of an index tag tree IT according to some embodiments of the present disclosure. The processing unit 124 creates multiple horizontal links HL according to the first tags TAG of the first-layer nodes FLN of the index tag tree IT. In an embodiment, as shown in FIG. 7C, taking the tag TG7 of the first-layer nodes FLN as an example, the processing unit 124 creates a horizontal link HL to the tag TG7 of the lower-layer node LLN connected to the tag of the first-layer node FLN (the horizontal link is the dotted arrow in FIG. 7C). By analogy, each lower-layer node LLN would establish a horizontal link HL with the first-layer node FLN or the lower-layer node LLN. The horizontal link HL can easily search the correlation between the first-layer nodes FLN and the lower-layer nodes LLN, thereby increasing the browsing speed and requiring only a small quantity of memory. After the horizontal link HL is established, the establishment of the index tag tree IT is completed, and finally the index tag tree IT is output for the user to browse.

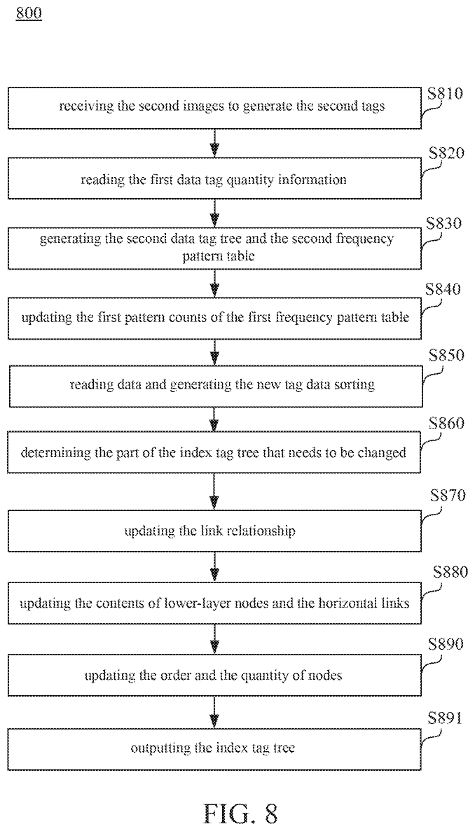

Please refer to FIG. 8, and FIG. 8 is a flowchart of a social media information processing method 800 after a new image is input according to some embodiments of the present disclosure. As shown in FIG. 8, the social media information processing method 800 after a new image is input includes steps S810-S891. In step S810, the user selects and inputs multiple second input images IMG2 through the input unit 122 of the mobile device 120, and automatically generates tags corresponding to the second input image for contents of each of the second input images IMG2 through the processing unit 124. The second tag includes a location tag, a calendar tag, and a time tag. In one embodiment, the user inputs two images shoot in 2018 at the log cabin muffin shop at the Chiao-Tung University, and the tags automatically generated by the processing unit 124 for the two images are tag the TG5 (2018), the tag TG1 (the Chiao-Tung University) and the tag TG2 (the log cabin muffin).

In step S820, the processing unit 124 reads multiple tags in the first tag data table 410 in FIG. 4, the first data tag tree TT1 in FIG. 5 and multiple first tag frequency patterns FP1 in FIG. 6.

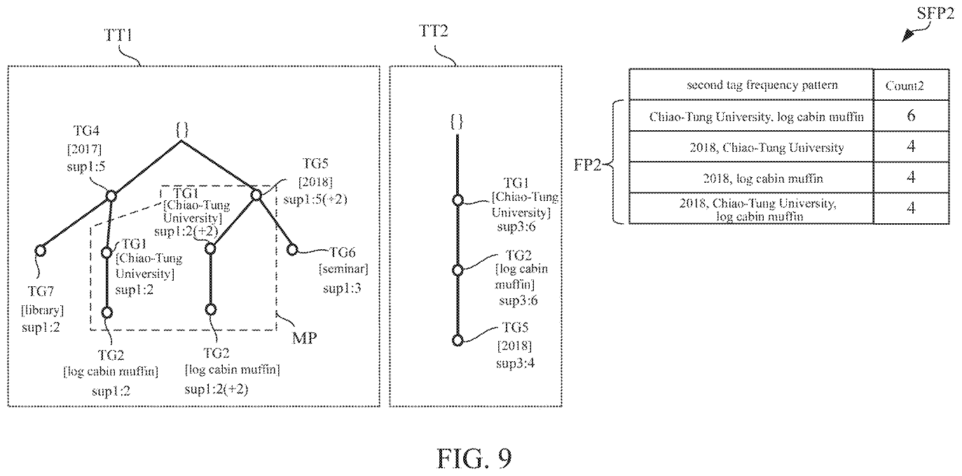

In step S830, please refer to FIG. 9, and FIG. 9 is a schematic diagram of establishing a second data tag tree TT2 according to some embodiments of the present disclosure.

After newly inputting two second input images IMG2, the processing unit 124 automatically generates tags corresponding to the two second input images IMG2 as the tag TG5 (2018), the tag TG1 (the Chiao-Tung University) and the tag TG2 (the log cabin muffin), and forms a second data tag tree TT2 shown in FIG. 9 according to the two newly inputting second input images IMG2. Next, it compares the tags included in the first data tag tree TT1 with the tag TG5 (2018), the tag TG1 (the Chiao-Tung University) and the tag TG2 (the log cabin muffin) in the second input images IMG2, and find the matching node part MP. Next, it adds up the first pattern counts Count1 of the tags of the matching node part MP and the respective quantities of the tags TG5, TG1 and TG2 of the two second input images IMG2. This causes that the quantity of tag TG5 to increase from 5 to 7 (including the quantity 5 of the first support sup1 of the tag TG5 in the original first data tag tree TT1 plus the quantity 2 of the two second input images IMG2), the quantity of tag TG1 is increased from 4 to 6 (including the quantity 2+2 of first support sup1 of tag TG1 in the original first data tag tree TT1 plus the quantity 2 of two second input images IMG2), and the quantity of tag TG2 is increased from 4 to 6 (including the quantity 2+2 of first support sup1 of tag TG2 in the original first data tag tree TT1 plus the quantity 2 of two second input images IMG2). Next, the second data tag tree TT2 is established according to the matching node part MP and the updated quantity (i.e. the third support degree sup3). The structure of the second data tag tree TT2 includes, from top to bottom, nodes of the tag TG1 (its third support degree sup3 is 6), the tag TG2 (its third support degree sup3 is 6), and the tag TG5 (its third support degrees sup3 is 4). Next, the second tag frequency pattern table SFP2 is generated according to the second data tag tree TT2. The second tag frequency pattern table SFP2 contains multiple second tag frequency patterns FP2 and the quantities thereof are the second pattern counts Count2, and the second tag frequency pattern FP2 includes multiple tags. Taking the first second tag frequency pattern FP2a in the second tag frequency pattern table SFP2 as an example, the second tag frequency pattern FP2a is the Chiao-Tung University (tag TG1) and log cabin muffin (tag TG2). The second pattern count Count2 of the second tag frequency pattern FP2a is 6. This means that in the second data tag tree TT2, the quantity of combination of the contents of the tags of the Chiao-Tung University and the log cabin muffin is 6.

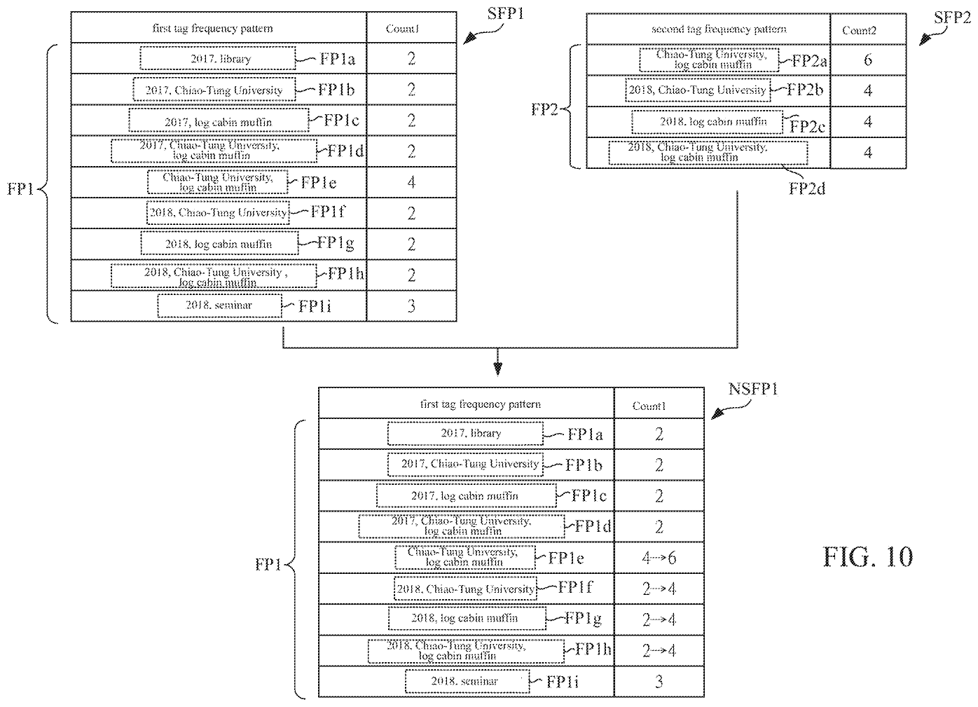

In step S840, please refer to FIG. 10, and FIG. 10 is a schematic diagram of generating a new first tag frequency pattern table NSFP1 according to some embodiments of the present disclosure. In an embodiment, as shown in FIG. 10, the processing unit 124 compares the first tag frequency patterns FP1 of the first tag frequency pattern table SFP1 with the second tag frequency patterns FP2 of the second tag frequency pattern table SFP2. If the content has matched, the corresponding second pattern count Count2 is used to update the first tag count Count1 among the first tag frequency pattern FP1. In this embodiment, the first tag frequency patterns FP1 of the first tag frequency pattern table SFP1 contain nine patterns, such as the first tag frequency patterns FP1a to FP1i shown in FIG. 10. The second tag frequency patterns FP2 of the second tag frequency pattern table SFP2 contain four patterns in total, such as the second tag frequency patterns FP2a to FP2d shown in FIG. 10.

As shown in FIG. 10, the first tag frequency pattern FP1e (including the tag TG1 and the tag TG2) matches the second tag frequency pattern FP2a, so in the updated new first tag frequency pattern table NSFP1, the count of the first tag frequency pattern FP1e is updated from 4 to 6 (Equal to the second pattern count Count2 of the second tag frequency pattern FP2a).

The first tag frequency pattern FP1f (including the tag TG5 and the tag TG1) matches the second tag frequency pattern FP2b, so in the updated new first tag frequency pattern table NSFP1, the count of the first tag frequency pattern FP1e is updated from 2 to 4 (equal to the second pattern count Count2 of the second tag frequency pattern FP2b).

The updating method of the first pattern count Count1 of the matched first tag frequency patterns FP1g and FP1h can be deduced by analogy. If the corresponding result does not match, the first pattern count Count1 of the first frequency pattern FP1 is not updated, that is, the original count is maintained. For example, the first tag frequency patterns FP1a-FP1d and FP1i cannot find the matching content in the second tag frequency pattern table SFP2, so the first pattern count Count1 of the first tag frequency pattern FP1a remains at 2 and is not updated. By analogy, the remaining first tag frequency patterns FP1b, FP1c, FP1d, and FP1i that do not match the corresponding results all maintain the original first pattern count Count1, and a new first tag frequency pattern table NSFP1 is generated after the comparison is updated. It can be seen that the social media information processing method 200 can gradually update the first pattern counts Count1 that needs to be updated among the nine tag frequency patterns FP1 when a new image is input, and there is no need to re-read the tag data of each newly input image to create a new first tag TT1, so as to save the reading calculation time.

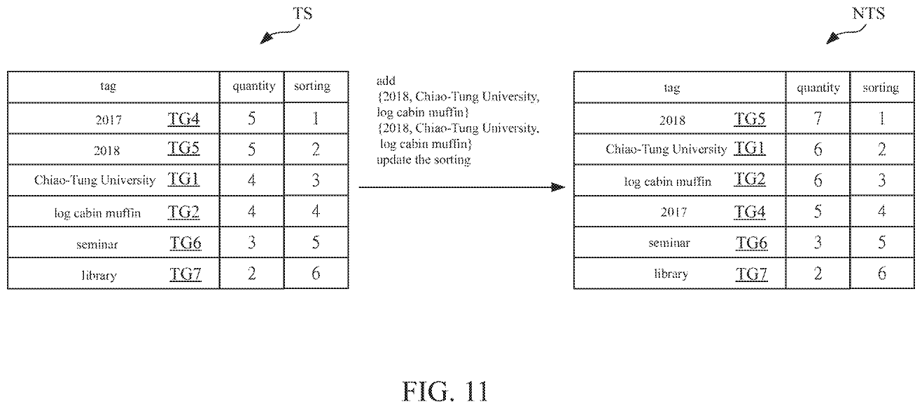

In step S850, after the two second input images IMG2 are input, the processing unit 124 automatically generates the tag TG5, the tag TG1, and the tag TG2. Next, the processing unit 124 reads the index tag tree IT, multiple first-layer nodes FLN and multiple lower-layer nodes LLN on the index tag tree IT, and reads a new first tag frequency pattern table NSFP1. Please refer to FIG. 11, and FIG. 11 is a schematic diagram of updating the tag quantity sorting TS according to some embodiments of the present disclosure. The processing unit 124 updates the tag quantity sorting TS according to the tags TG5, TG1 and TG2 generated by the two second input images IMG2, and generates a new tag quantity sorting NTS.

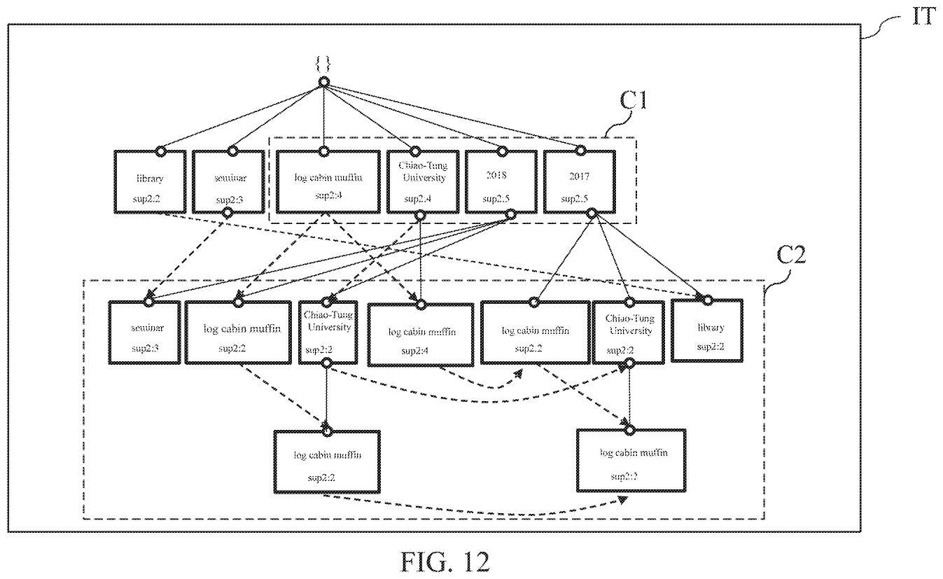

In step S860, in an embodiment, please refer to FIG. 11 and FIG. 12 together, and FIG. 12 is a schematic diagram of determining changing parts of the index tag tree according to some embodiments of the present disclosure. In an embodiment, as shown in FIG. 12, the processing unit 124 determines a part C1 of the first-layer nodes to be changed in the index tag tree IT according to the new tag quantity sorting NTS. For example, the first-layer nodes FLN of the index tag tree IT are from right to left, and the rightmost 2017 starts from 2018, the Chiao-Tung University, the log cabin muffin, the seminar, and the leftmost library. The above sorting is different from the order of the new tag quantity sorting NTS (the order is 2018 in sort 1, the Chiao-Tung University in sort 2, the log cabin muffin in sort 3, 2017 in sort 4, the seminar in sort 5, and the library in sort 6). In order to comply with the new tag quantity sorting NTS, from the rightmost of 2017, to 2018, to the log cabin muffin to the Chiao-Tung University is a part C1 of the first-layer nodes FLN that need to be changed. Next, it is determined that the lower-layer nodes LLN connected to it is a part C2 of the lower-layer nodes LLN to be changed according to the first-layer nodes FLN which are 2017, 2018, the Chiao-Tung University and the log cabin muffin.

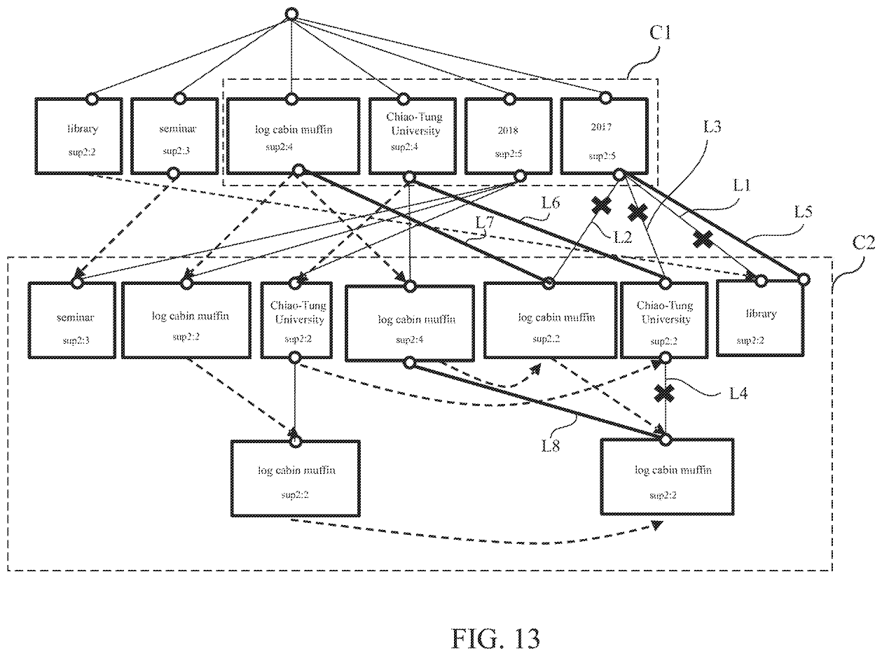

In step S870, please refer to FIG. 13, and FIG. 13 is a schematic diagram of updating connection relationship of an index tag tree according to some embodiments of the present disclosure. The processing unit 124 releases the original connection relationship with the part C1 of the first-layer node that need to be changed according to a part C2 of the lower-layer nodes LLN that need to be changed, and then re-establish a new connection relationship with the first-layer nodes FLN which are 2017 (tag TG4), 2018 (tag TG5), the Chiao-Tung University (tag TG1) and the log cabin muffin (tag TG2) according to the new tag quantity sorting NTS. As shown in FIG. 13, taking the first-layer node FLN which is 2017 as an example, the original linking relationship L1 between the lower-layer nodes LLN, which is the library (tag TG7) and needs to be changed, and the first-layer node FLN, which is 2017 (tag TG4), is released. The original link L2 between the lower-layer node LLN, which is the log cabin muffin (tag TG2), and the first-layer node FLN, which is 2017 (tag TG4) and needs to be changed, is released. The original link L3 between the lower-layer node LLN, which is the Chiao-Tung University (tag TG1), and the first-layer node FLN, which is 2017 (tag TG4) and needs to be changed, is released, and the original link L4 between the lower-layer node, which is the log cabin muffin (tag TG2), and the lower-layer node LLN, which is the Chiao-Tung University (tag TG1) and needs to be changed, is released. Next, the first tag frequency patterns FP1 in the new first tag frequency pattern table NSFP1 are read according to new tag quantity sorting NTS, and a new connection relationship is re-established. The lower-layer node LLN, which is the library (tag TG7), would establish a new connection relationship L5 with the first-layer node FLN, which is 2017 (tag TG4). The lower-layer node LLN, which is the Chiao-Tung University (tag TG1), would establish a new connection relationship L6 with the first-layer node FLN, which is the Chiao-Tung University (tag TG1). The lower-layer node LLN, which is the log cabin muffin (tag TG2), would establish a new connection relationship L7 with the first-layer node FLN, which is the log cabin muffin (tag TG2), and the lower-layer node LLN, which is the log cabin muffin (tag TG2), would establish a new connection relationship L8 with the first-layer node FLN, which is the log cabin muffin (tag TG2). By analogy, if a part C2 of the connection relationship of the remaining lower-layer nodes needs to be changed, the connection relationship is also updated in the above manner.

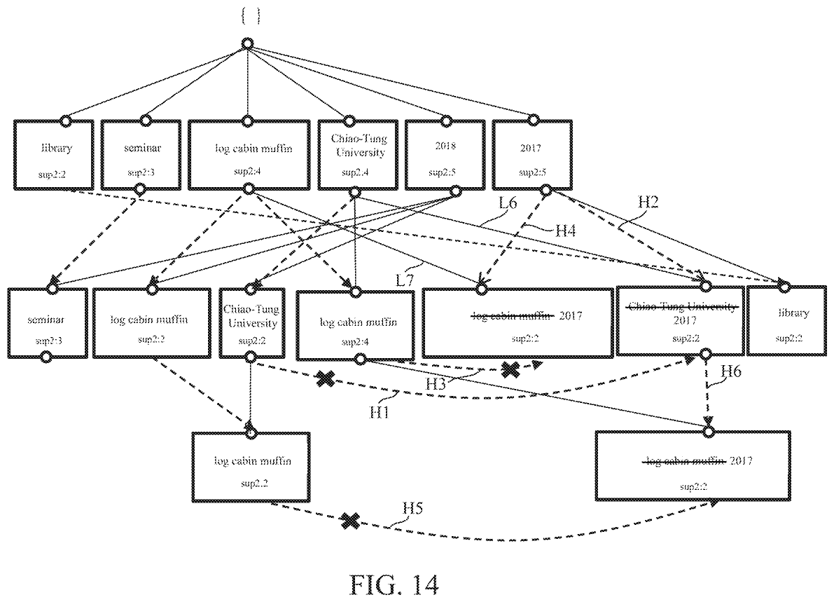

In step S880, please refer to FIG. 14, and FIG. 14 is a schematic diagram of updating contents of the lower-layer nodes LLN and the horizontal links HL according to some embodiments of the present disclosure. As shown in FIG. 14, taking the lower-layer nodes LLN which are the Chiao-Tung University (tag TG1) and the log cabin muffin (tag TG2) as an example, the processing unit 124 updates the lower nodes LLN from the Chiao-Tung University (tag TG1) to 2017 (tag TG4) according to the new link relationship L6 established by the lower-layer node LLN, which is the Chiao-Tung University (tag TG1), and the first-layer node FLN, which is the Chiao-Tung University (tag TG1), in the index tag tree, and releases the horizontal connection H1 originally connected to this lower-layer node LLN, and adds a horizontal link H2 to the first-layer node FLN, which is 2017 (tag TG4). And, it updates the lower nodes LLN from the log cabin muffin (tag TG2) to 2017 (tag TG4) according to the new link relationship L7 established by the lower-layer node LLN, which is the log cabin muffin (tag TG2), and the first-layer node FLN, which is the log cabin muffin (tag TG2), in the index tag tree, and releases the horizontal connection H3 originally connected to this lower-layer node LLN, and adds a horizontal link H4 to the first-layer node FLN, which is 2017 (tag TG4). And, it updates the lower nodes LLN from the log cabin muffin (tag TG2) to 2017 (tag TG4) according to the new link relationship L8 established by the lower-layer node LLN, which is the log cabin muffin (tag TG2), and the lower-layer node LLN, which is the log cabin muffin (tag TG2), in the index tag tree, and releases the horizontal connection H5 originally connected to this lower-layer node LLN, and adds a horizontal link H6 to the lower-layer node LLN, which is 2017 (tag TG4).

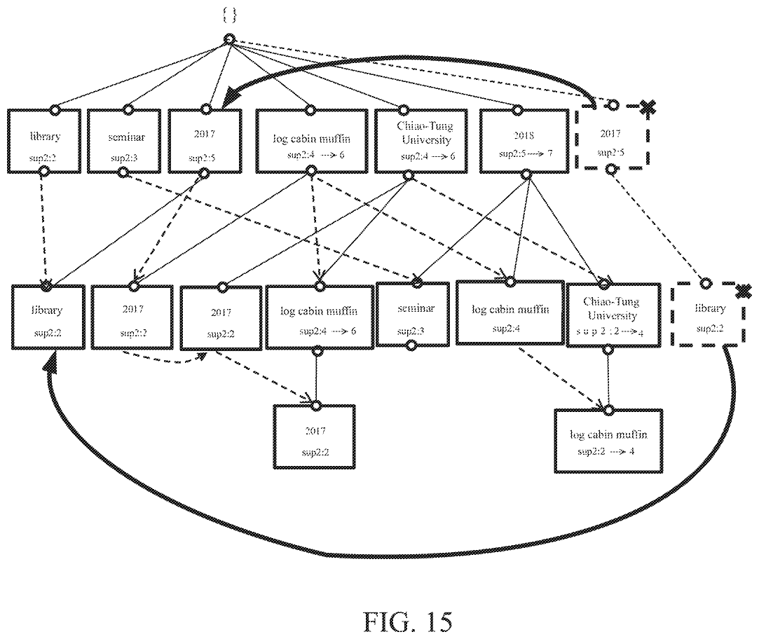

In step S890, please refer to FIG. 15, and FIG. 15 is a schematic diagram of updating of the arrangement order and quantity of the first-layer nodes FLN and the lower-layer nodes LLN of an index tag tree according to some embodiments of the present disclosure. As shown in FIG. 15, taking the first-layer node FLN, which is 2017 (tag TG4), of the index tag tree as an example, the processing unit 124 updates the first-layer node FLN, which is 2017 (tag TG4), from the rightmost first node to the node between the log cabin muffin (tag TG2) of the first-layer node FLN and the seminar (tag TG6) of the first-layer node FLN according to the new tag quantity sorting NTS, and the library (tag TG7) of the lower-layer nodes LLN which is connected to the first-layer node FLN which is 2017 (tag TG4) is to be updated from the rightmost lower-layer node LLN to the leftmost lower-layer node LLN. By analogy, the updating of the arrangement order of other first-layer nodes and lower-layer nodes LLN will not be described here. In addition, because there are two second input images IMG2 input, the processing unit 124 automatically generates two sets of tags for 2018 (tag TG5), the Chiao-Tung University (tag TG1) and the log cabin muffin (tag TG2), and the processing unit 124 would update the statistical quantities (i.e. the second support degree sup2) of the first-layer nodes FLN according to the tag quantity information of the second tags in the new tag quantity sorting NTS, where the second support degree sup2 of the first layer node FLN, which is 2018 (tag TG5), is updated from 5 to 7, the second support degree sup2 of the first-layer node FLN, which is the Chiao-Tung University (tag TG1), is updated from 4 to 6, and the second support degree sup2 of the first-layer node FLN, which is log cabin muffin (Tag TG2), is updated from 4 to 6. The statistical quantities (i.e. the second support degree sup2) of the lower-layer nodes LLN would be updated according to quantities in the new first tag frequency pattern table NSFP1. For example, the second support degree sup2 of the lower-layer node LLN (the log cabin muffin (tag TG2)), which is connected to the first-layer node FLN (the Chiao-Tung University (tag TG1)), is updated from 4 to 6. The second support degree sup2 of the lower-layer node LLN (the Chiao-Tung University (tag TG1)), connected to the first-layer node FLN (2018 (tag TG5)), is updated from 2 to 4. The second support degree sup2 of the lower-layer node LLN (the log cabin muffin (tag TG2)), connected to the first-layer node FLN (the Chiao-Tung University (tag TG1)), is updated from 2 to 4. The second support degree sup2 of the lower-layer node LLN (the log cabin muffin (tag TG2)), connected to the lower-layer node LLN (the Chiao-Tung University (tag TG1)), and then connected to the first-layer node FLN (2018 (tag TG5)), is updated from 2 to 4. At this time, the update of the index tag tree is completed to generate a new index tag tree NIT.

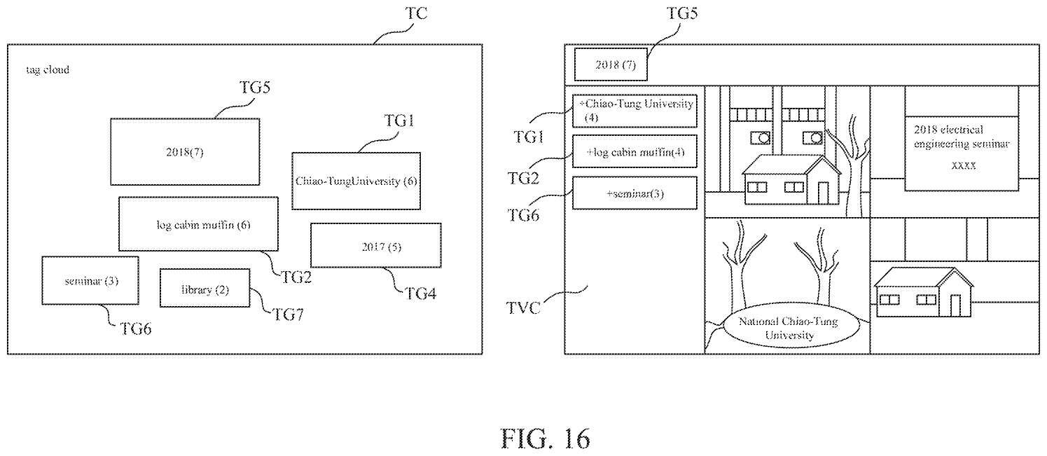

In step S891, please refer to FIG. 16, and FIG. 16 is a schematic diagram of outputting an index tag tree according to some embodiments of the present disclosure. As shown in FIG. 16, the output unit 180 outputs the new index tag tree NIT. This output is displayed as a tag cloud TC on the user interface. The tag cloud TC includes tags TAG1 corresponding to the first input images IMG1 or tags corresponding to the second input images IMG2. In one embodiment, the tag cloud TC includes tags 2018 (tag TG5), the Chiao-Tung University (tag TG1), the log cabin muffin (tag TG2), 2017 (tag TG4), the seminar (tag TG6) and the library (tag TG7). If the user clicks on 2018 (tag TG5), and then the tag content information TCI will be expanded. The tag content information TCI includes the tag quantity display column TVC and all automatically generated images including 2018 (tag TG5) for the user to browse. In this embodiment, there are 7 images including 2018 (tag TG5), where the tag quantity display column TVC includes all other tags that are directly connection relationship with 2018 (tag TG5) and their quantities in the new index tag tree NIT. The tag quantity display column TVC can show which other tags are related to 2018 (tag TG5). Users can click on other tabs from the tag quantity display column TVC to further narrow the scope of browsing, and then find the images they are interested in.

In one embodiment, the users can use the home network server 140 to calculate the home index tag tree HIT by computing multiple client terminals in the home based on the respective input images and the new index tag tree NIT generated by each user. The output unit 180 displays the home index tag tree HIT on the user interface in the form of a tag cloud TC. Multiple client terminals in the family can quickly browse through the images shared by each member of the family through the home network server 140, and then find the images that interest them.

In another embodiment, the client terminal can select multiple social network client terminals to share on the social network through the social network server 160. Multiple social network client terminals calculate their social network index tag tree SIT through the social network server 160 based on their respective input images and their new index tag tree NIT. Further, through the output unit 180, the social network index tag tree SIT is displayed on the user interface in the form of a tag cloud TC. Multiple client terminals on the social network can quickly browse the images shared on the social network through the social network server 160, and then find the images that interest them.

As a result, after the operations described in the above embodiments, the user can use the social media information processing method and system to systematically integrate the shared images and establish a fast index structure, and through the home network server 140 or the social network server 160 to efficiently search for content of interest in the images shared by family or friends.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A social media information processing method, comprising:
reading a plurality of first tags, a first data tag tree and a plurality of first tag frequency patterns related to a plurality of first input images;
inputting a plurality of second input images;
generating a plurality of second tags related to the plurality of second input images according to a plurality of second input images;
updating a plurality of first pattern counts of the plurality of first tag frequency patterns according to the plurality of second tags;
adjusting a plurality of first-layer nodes and a plurality of lower-layer nodes involving the plurality of second tags in an index tag tree, to generate a new index tag tree; and
adjusting a display content of a user interface according to the new index tag tree,
wherein the display content comprises a tag cloud and a tag quantity display row,
wherein the tag cloud and the tag quantity display row are configured to display a correlation between the plurality of first tags of the plurality of first input images and the plurality of second tags of the plurality of second input images.

2. The social media information processing method of claim 1, wherein the steps of updating the plurality of first pattern counts of the plurality of first tag frequency patterns comprises:
comparing contents of the plurality of first tags of the first data tag tree with the plurality of second tags;
reading a plurality of statistical quantities of nodes, which match the plurality of second tags, in the first data tag tree;
summing the plurality of statistical quantities and a tag quantity generated by each of the plurality of second tags to generate a plurality of new statistical quantities;
generating a second data tag tree according to the plurality of new statistical quantities and the plurality of second tags, wherein a plurality of nodes of the second data tag tree respectively correspond to one of the second tags;
generate a second tag frequency pattern table according to the second data tag tree, wherein the second tag frequency pattern table comprises a plurality of second tag frequency patterns and a plurality of second pattern counts of the plurality of second tag frequency patterns, and each of the second tag frequency patterns is any combination of each of the second tags;
acquiring one of first tag frequency patterns in the first tag frequency pattern table which matches contents of the second tag frequency patterns in the second tag frequency pattern table, and updating the first pattern count of a matched first tag frequency pattern to the second pattern count of the second tag frequency pattern which the content is matched; and
acquiring one of first tag frequency patterns which do not matches the contents of the second tag frequency patterns, and maintaining the first pattern count of the first tag frequency pattern which is not matched.

3. The social media information processing method of claim 1, wherein the steps of generating the index tag tree comprises:
reading the index tag tree, the plurality of first-layer nodes and the plurality of lower-layer nodes in the index tag tree;
reading the plurality of new statistical quantities generated by summing the plurality of statistical quantities of the nodes in the first data tag tree which match the plurality of second tags and tag quantities generating by each of the second tags;
reading the updated first tag frequency pattern table;
generating a new tag quantity sorting according to the new statistical quantities when the plurality of second tags exist in the plurality of first-layer nodes of the index tag tree;
determining a part of the plurality of first-layer nodes that need to be changed according to the new tag quantity sorting;
determining a part of the plurality of lower-layer nodes that need to be changed according to a part of the plurality of first-layer nodes that need to be changed;
releasing a part of the plurality of lower-layer nodes that need to be changed and an original connection relationship of a part of the first-layer nodes that need to be changed according to a part of the lower nodes that need to be changed;
establishing a new connection relationship between a part of the plurality of lower-layer nodes that need to be changed and a part of the plurality of first-layer nodes that need to be changed according to the new tag quantity sorting;
updating contents of the second tags of a part of the plurality of lower-layer nodes to be changed according to the new connection relationship;
according to the new connection relationship, releasing the original horizontal links of a part of the plurality of lower-layer nodes that need to be changed and a part of the plurality of first-layer nodes that need to be changed, and establishing a plurality of new horizontal links of a part, which has been changed, of the plurality of lower-layer nodes and a corresponding part of the plurality of first-layer nodes that need to be changed; and
updating orders of the plurality of first-layer nodes and the plurality of lower-layer nodes according to the new tag quantity sorting, updating statistical quantities of the plurality of first-layer nodes according to the tag quantity of the second tag, and updating statistical quantities of the plurality of lower-layer nodes according to the updated first tag frequency pattern table.

4. The social media information processing method of claim 3, further comprising the following steps to generate the plurality of first tags, the first data tag tree, and the plurality of tag frequency patterns:
inputting the plurality of first input images;
generating the plurality of first tags related to the plurality of first input images according to the plurality of first input images;
establishing a tag quantity sorting according to tag quantity statistics generated by each of the plurality of first tags;
reading the plurality of first tags related to the plurality of first input images according to the tag quantity sorting, and establishing the first data tag tree according to correlations of the plurality of first tags, wherein a plurality of nodes of the first data tag tree respectively correspond to one of the plurality of first tags; and
generating a first tag frequency pattern table according to the first data tag tree, wherein the first tag frequency pattern table includes the plurality of first tag frequency patterns and a plurality of first pattern counts of the plurality of first tag frequency patterns, wherein each of the plurality of first tag frequency patterns is any combination of each of the plurality of first tags.

5. The social media information processing method of claim 4, further comprising the following steps to generate the index tag tree, the plurality of first-layer nodes and the plurality of lower-layer nodes in the index tag tree:
determining whether the tag quantity generated by each of the plurality of first tags is greater than an index tag quantity threshold;
creating each of the plurality of first tags into the plurality of first-layer nodes of the index tag tree in order from small to large according to the tag quantity sorting of the plurality of first tags when the tag quantity of the first tag is greater than the index tag quantity threshold, wherein the index tag tree includes the plurality of first-layer nodes and the plurality of lower-layer nodes, wherein each of the plurality of first-layer nodes and each of the plurality of lower-layer nodes respectively correspond to one of the plurality of first tags;
reading the plurality of first tag frequency patterns according to the plurality of first-layer nodes of the index tag tree, and arranging each of the plurality of tag frequency patterns according to the tag quantity sorting in reverse order from large to small from the plurality of lower-layer nodes;
establishing a plurality of horizontal links to the plurality of lower-layer nodes that match first tags of the plurality of first-layer nodes according to the plurality of first-layer nodes of the index tag tree; and
not creating the first tag into the index tag tree when the tag quantity of the first tag is smaller than the index tag quantity threshold.

6. The social media information processing method of claim 1, further comprising:
generating a home index tag tree provided to a plurality of client terminals according to the input images shared by the plurality of client terminals and a plurality of index tag tree shared by the plurality of client terminals.

7. The social media information processing method of claim 1, further comprising:
selecting the plurality of input images to be shared by a plurality of client terminals, selecting the index tag tree to be shared by the plurality of client terminals, and selecting a plurality of sharing targets to be shared by the plurality of client terminals; and
generating a social network index tag tree provided to the plurality of sharing targets according to the plurality of input data that the plurality of client terminals want to share and the index tag tree that the plurality of client terminals want to share.

8. A social media information processing system, comprising:
an input unit configured to input a plurality of first input images and a plurality of second input images shared by a plurality of client terminals;
a processing unit configured to generate the new index tag tree according to the plurality of first input images and the plurality of second input images; and
an output unit configured to display an output result of the new index tag tree,
wherein the new index tag tree affects the display result of a tag cloud and a tag quantity display column of an user interface,
wherein the tag cloud and the tag quantity display column show correlations between the plurality of first tags of the plurality of first input images and the plurality of second tags of the plurality of second input images.

9. The social media information processing system of claim 8, further comprising:
a home network server configured to output a home index tag tree provided to the plurality of client terminals according to the plurality of first input images and the plurality of second input images shared by the plurality of client terminals and a plurality of index tag trees shared by the plurality of client terminals.

10. The social media information processing system of claim 8, further comprising:
a social network server configured to select the plurality of input images that the plurality of client terminals want to share, selecting the plurality of index tag trees that the plurality of client terminals want to share, and selecting a plurality of sharing targets that the plurality of client terminals want to share,
wherein the social network server outputs a social network index tag tree provided to the plurality of sharing targets according to the plurality of input data that the plurality of client terminals want to share and the plurality of index tag trees that the plurality of client terminals want to share.
